(19) United States
(12) Patent Application Publication
(10) Pub. No.: US 2024/0430213 A1
(43) Pub. Date: Dec. 26, 2024

(54) ELECTRONIC DEVICES MOUNTED ON AUTONOMOUS VEHICLES, ELECTRONIC SYSTEMS INCLUDING THE SAME, AND OPERATION METHODS THEREOF

(71) Applicant: Samsung Electronics Co., Ltd., Suwon-si (KR)

(72) Inventors: Jinwook Lee, Suwon-si (KR); Seungcheol Lee, Suwon-si (KR); Seunghan Lee, Suwon-si (KR)

(21) Appl. No.: 18/675,488

(22) Filed: May 28, 2024

(30) Foreign Application Priority Data
Jun. 23, 2023 (KR) 10-2023-0081409

(51) Int. Cl. H04L 47/6295; B60W 60/00

(52) U.S. Cl. CPC H04L 47/6295; B60W 60/0011

(57) ABSTRACT

An electronic device, which is configured to be mounted on an autonomous vehicle, includes: a first interface circuit configured to communicate with a plurality of storage devices, a second interface circuit configured to communicate with a plurality of zones of the autonomous vehicle, an event detector configured to output an event signal in response to detecting event data received through the second interface circuit, an event manager configured to output a data division signal in response to the event signal, and an interface manager. The interface manager is configured to: divide the event data into a plurality of data fragments in response to the data division signal, allocate the plurality of data fragments to two or more storage devices among the plurality of storage devices, respectively, and control the first interface circuit such that the plurality of data fragments are respectively transmitted to the allocated two or more storage devices.

### REFERENCE TO PRIORITY APPLICATION

This application claims priority under 35 U.S.C. § 119 to Korean Patent Application No. 10-2023-0081409, filed Jun. 23, 2023, the disclosure of which is hereby incorporated herein by reference.

### BACKGROUND

Embodiments of the present disclosure described herein relate to electronic devices and, more particularly, to electronic devices to be mounted on autonomous vehicles, electronic systems including the same, and methods of operating autonomous vehicles.

Nowadays, a storage device, which uses a memory device, such as a solid state drive (SSD), is being widely used. Because this type of storage device does not include a mechanical driving unit, the storage device provides excellent stability and endurance and is advantageous in that a speed to access information is very fast and power consumption is relatively small.

When a vehicle accident occurs, a function of recording data generated inside the vehicle is required, and an event data recorder (EDR), which may operate as a vehicular “black box”, may store data generated in the vehicle during a given time period before and after the accident. With the recent advent of autonomous vehicles (e.g., self-driving vehicles), the size of data that needs to be recorded/preserved in the event of an accident has increased in order to adequately study the safety of such vehicles and for the purpose of analyzing the exact cause of the accident, which may occur in the vehicle, through a camera, a light detection and radar (LIDAR) sensor, and any other radar (RAdio Detection And Ranging). Also, as the in-vehicle information (IVI), an HD Map, an ADAS, an NPU, etc. are applied to the architecture of the autonomous vehicle, the quantity of data required by the autonomous vehicle increases. Accordingly, in the case of failing to quickly store the data generated in the vehicle in the event of the accident, data necessary to analyze the cause of the accident may be lost due to a breakdown of the vehicle. Thus, it would be advantageous to quickly record large quantities of data in the event of an accident.

### SUMMARY

Embodiments of the present disclosure provide an electronic device capable of quickly recording data in a state of being mounted on an autonomous vehicle, an electronic system including the same, and an operation method thereof.

According to an embodiment, an electronic device mounted on an autonomous vehicle may include a first interface circuit that communicates with a plurality of storage devices, a second interface circuit that communicates with a plurality of zones of the autonomous vehicle, an event detector that outputs an event signal in response to detecting event data received through the second interface circuit, an event manager that outputs a data division signal in response to the event signal, and an interface manager that divides the event data into a plurality of data fragments in response to the data division signal, allocates the plurality of data fragments to two or more storage devices among the plurality of storage devices, respectively, and controls the first interface circuit such that the plurality of data fragments are respectively transmitted to the allocated two or more storage devices in parallel.

According to an embodiment, an electronic system may include an electronic device mounted on an autonomous vehicle, zone control units that respectively correspond to a plurality of zones of the autonomous vehicle, and a plurality of first storage devices each including an event data space. The electronic device may divide event data received from one of the zone control units into a plurality of data fragments, may allocate the plurality of data fragments to two or more first storage devices among the plurality of first storage devices, and may transmit the plurality of data fragments to the two or more first storage devices in parallel, respectively. Each of the two or more first storage devices may write the corresponding data fragment among the plurality of data fragments in the event data space.

According to another embodiment, an operation method of an electronic device mounted on an autonomous vehicle may include detecting event data, outputting an event signal, when the event data are detected, dividing the event data into a plurality of data fragments in response to the event signal, allocating the plurality of data fragments to two or more storage devices, and transmitting the plurality of data fragments to the two or more storage devices thus allocated, in parallel.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an electronic device according to an embodiment of the present disclosure.

FIG. 2 is a block diagram illustrating an electronic system including an electronic device of FIG. 1.

FIG. 3 is a block diagram illustrating an example of one of a plurality of storage devices of FIG. 1.

FIG. 4 is a diagram for describing an operation in which an electronic device of FIG. 1 transmits a plurality of data fragments in parallel to two or more storage devices.

FIG. 5 is a diagram for describing a stream identifier according to an embodiment of the present disclosure.

FIG. 6 is a diagram for describing an operation of storing combined event data according to an embodiment of the present disclosure.

FIG. 7 is a diagram for describing how a data division operation is performed based on an available capacity of each of a plurality of storage devices, according to an embodiment of the present disclosure.

FIG. 8 is a diagram for describing how a data division operation is performed based on states of a plurality of queues, according to an embodiment of the present disclosure.

FIG. 9 is a diagram for describing an operation of transmitting data to each of a plurality of storage devices based on a priority of data, according to an embodiment of the present disclosure.

FIG. 10 is a diagram illustrating an Ethernet frame according to an embodiment of the present disclosure.

FIG. 11 is a flowchart illustrating an operation method of an electronic device according to an embodiment of the present disclosure.

FIG. 12 is a diagram illustrating a configuration of a plurality of storage devices according to another embodiment of the present disclosure.

FIG. 13 is a diagram for describing an example of a storage area of a storage device of FIG. 2.

FIG. 14 is a diagram illustrating an automotive zonal and centralized architecture of an autonomous vehicle.

### DETAILED DESCRIPTION

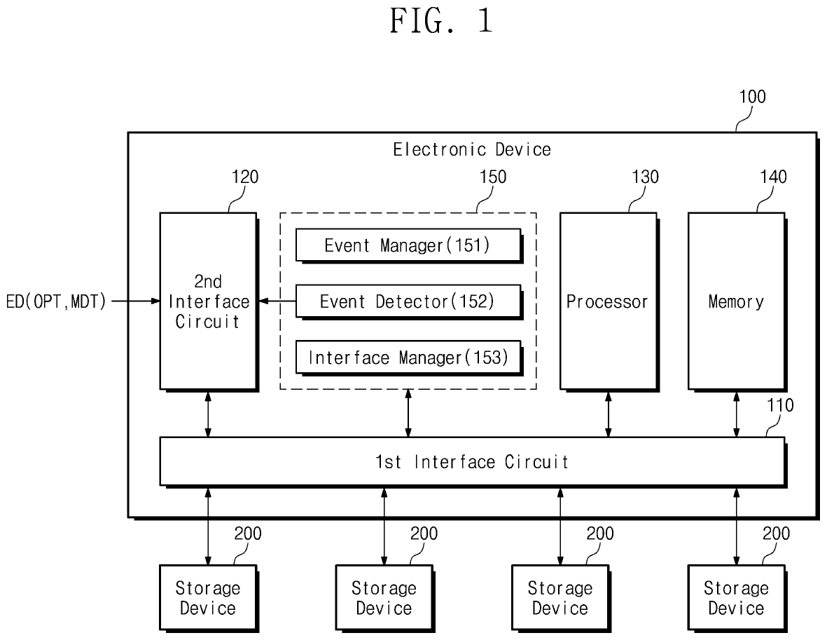

FIG. 1 is a block diagram illustrating an electronic device according to an embodiment of the present disclosure. Referring to FIG. 1, according to an embodiment of the present disclosure, an electronic device 100 that is mounted on the autonomous vehicle may include a first interface circuit 110, a second interface circuit 120, a processor 130, a memory 140, and an event processing circuit 150.

The first interface circuit 110 may provide an interface for bidirectional communication with a plurality of storage devices 200. The first interface circuit 110 may include at least one switch. When the first interface circuit 110 includes a plurality of switches, the plurality of switches may constitute a switch fabric. The first interface circuit 110 may transmit data in parallel to the plurality of storage devices 200. In contrast, the second interface circuit 120 may provide an interface for receiving various kinds of data from the outside of the electronic device 100, and the various kinds of data may include event data ED.

The event data ED that are data associated with the status of the vehicle or passenger are to be recorded during a given time period before and after a point in time when an event (e.g., a car crash) occurs. When a given trigger condition is satisfied, the event data ED are transmitted to the electronic device 100 from various kinds of devices including an electronic control device included in the vehicle, so as to be written in at least one of the storage devices 200. The event data ED helps analyze an accident situation occurring in the autonomous vehicle.

The event data ED may be classified as mandatory item data MDT and optional item data OPT. The mandatory item data MDT are the event data ED that need to be recorded, as mandatory, and correspond to data with relatively high importance. The optional item data OPT may be the event data ED whose record is determined depending on settings and may correspond to data with relatively low importance even in the event of an accident.

Items of the event data ED may include a VRU (Vulnerable Road User) item, an ACC (Adapted Cruise Control) item, an ACSF (Automatically Commanded Steering Function) item, a commanded steering function item, an LDWS (Lane Departure Warning System) item, an advanced emergency braking system item, etc. Each item may be collected at a given period.

The processor 130 may execute one or more instructions stored in the memory 140. The processor 130 may be implemented with a hardware component that performs arithmetic, logic, and input/output operations and signal processing. For example, the processor 130 may be implemented with at least one of a central processing unit, a microprocessor, a graphic processing unit, application specific integrated circuits (ASICs), digital signal processors (DSPs), digital signal processing devices (DSPDs), programmable logic devices (PLDs), and field programmable gate arrays (FPGAs), but the present disclosure is not limited thereto. The processor 130 may control an overall operation of the electronic device 100 through the execution of the instructions.

The memory 140 may include, for example, a nonvolatile memory including at least one of a memory (e.g., an SD or XD memory) of a flash memory type, a hard disk type, a multimedia card micro type, or a card type, a read-only memory (ROM), and an electrically erasable programmable read-only memory (EEPROM), a programmable read-only memory and a volatile memory device such as a random access memory (RAM) or a static random access memory (SRAM).

The instructions readable by the processor 130, a data structure, and a program code may be stored in the memory 140. The processor 130 may execute program instructions or codes stored in the memory 140. The event processing circuit 150 may store the received event data ED in some or all of the plurality of storage devices 200 and may include an event manager 151, an event detector 152, and an interface manager 153.

The event detector 152 may determine whether the second interface circuit 120 receives the event data ED. When it is determined that the event data ED are received through the second interface circuit 120, the event detector 152 may transmit an interrupt signal to the event manager 151. For example, the event detector 152 may detect the input of the event data ED based on a specific field of a packet that the second interface circuit 120 receives.

The event manager 151 may control the interface manager 153 to store the event data ED in some or all of the plurality of storage devices 200 in response to the interrupt signal from the event detector 152. For example, the event manager 151 may output a data division signal such that the interface manager 153 divides the event data ED.

Under control of the event manager 151, the interface manager 153 may divide the received event data ED into a plurality of data fragments. In the case of dividing the event data ED into the plurality of data fragments, the interface manager 153 may divide the event data ED in consideration of a unit size by which the storage devices 200 store data. For example, the interface manager 153 may divide the event data ED into the plurality of data fragments based on a mapping size applied to the storage devices 200.

The interface manager 153 may control the first interface circuit 110 such that the plurality of data fragments are transmitted in parallel to two or more storage devices among the plurality of storage devices 200. Under control of the interface manager 153, the first interface circuit 110 may transmit the plurality of data fragments to some or all of the plurality of storage devices 200, including in parallel. As such, a time taken to store the event data ED may be shortened.

With the development of vehicle technologies, various sensing information are collected from various kinds of cameras and various kinds of sensors including LIDAR, and the size of the event data ED is increasing as a driving automation level becomes higher. The event processing circuit 150 may quickly write the event data ED by transmitting the event data ED in parallel to some or all of the plurality of storage devices 200.

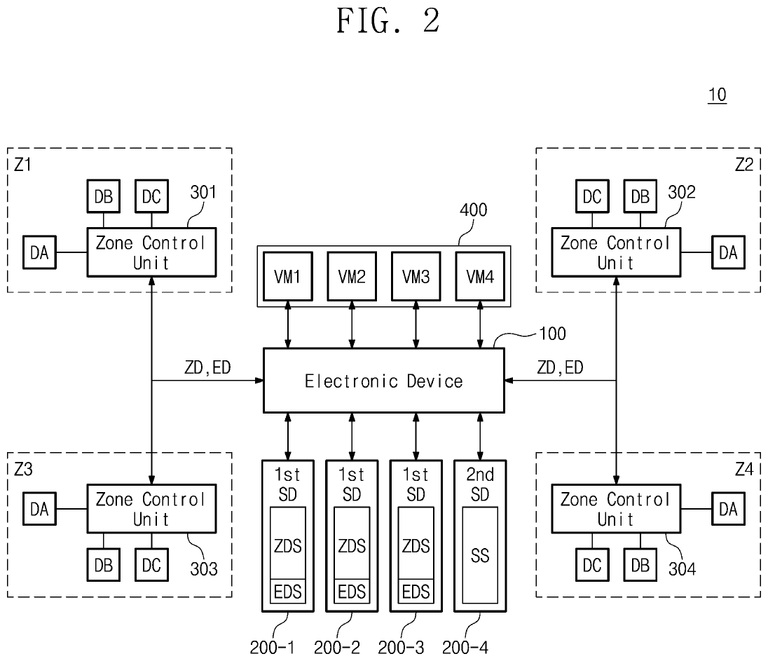

FIG. 2 is a block diagram illustrating an electronic system including an electronic device of FIG. 1. Referring to FIG. 2, according to an embodiment of the present disclosure, an electronic system 10 that includes the electronic device 100 mounted on the autonomous vehicle may further include zone control units 301, 302, 303, and 304 respectively corresponding to a plurality of zones Z1, Z2, Z3, and Z4 of the autonomous vehicle, a plurality of first storage devices 200-1, 200-2, and 200-3, and a central processor 400.

Nowadays, in an electric/electronic system controlling a vehicle, an automotive zonal & centralized architecture field is being studied. According to the automotive zonal & centralized architecture, the electric/electronic system of the vehicle may be divided into zones being a smaller unit easy to manage. The plurality of zones, Z1 to Z4, may be determined for respective physical locations and regions of the vehicle. The vehicle to which the automotive zonal & centralized architecture is applied may process specific functions within the zones Z1 to Z4 and may also process a specific function through the central processor 400. The automotive zonal & centralized architecture may make it possible to reduce complexity of a cable harness and to easily add various kinds of devices to the vehicle.

Various kinds of automotive devices DA, DB, and DC such as a sensor, an actuator, a camera, and an inertial measurement unit (IMU) may be disposed in each of the zones Z1 to Z4, and at least one zone control unit may be disposed in each of the zones Z1 to Z4. For example, the zone control units 301 to 304 may be respectively disposed in the zones Z1 to Z4. For example, in the first zone Z1, the automotive devices DA to DC are connected to the zone control unit 301. For example, the automotive device DA may be a sensor, the automotive device DB may be an actuator, and the automotive device DC may be a camera. The automotive devices DA to DC disposed in the first zone Z1 are provided as an example. For example, as well as the sensor, the actuator, and the camera described above, various kinds of devices for driving the vehicle may be disposed therein. The zone control unit 301 may transmit zone data ZD or the event data ED generated in the first zone Z1 to the electronic device 100. For example, in the second zone Z2, the automotive devices DA to DC are connected to the zone control unit 302. The zone control unit 302 may transmit the zone data ZD or the event data ED generated in the second zone Z2 to the electronic device 100. The zone control unit 303 may transmit the zone data ZD or the event data ED generated in the third zone Z3 to the electronic device 100, and the zone control unit 304 may transmit the zone data ZD or the event data ED generated in the fourth zone Z4 to the electronic device 100. Each of the zone control units 301 to 304 may transmit control signals to the automotive devices DA to DC disposed in the corresponding one of the zones Z1 to Z4 and may control the automotive devices DA to DC.

Each of the plurality of first storage devices 200-1, 200-2, and 200-3 may include a zone data space ZDS and an event data space EDS. The zone data space ZDS is a logical space for storing the zone data ZD received from the plurality of zone control units 301 to 304 or a plurality of virtual machines VM1 to VM4. The event data space EDS is a logical space for storing the event data ED that the electronic device 100 receives. The electronic device 100 may write the zone data ZD in the zone data space ZDS and may write the event data ED in the event data space EDS. That is, the zone data space ZDS and the event data space EDS may be logically distinguished from each other.

The central processor 400 may execute the plurality of virtual machine VM1, VM2, VM3, and VM4. The plurality of virtual machines VM1 to VM4 may respectively control the corresponding zones Z1 to Z4. For example, the virtual machine VM1 may control the electronic control devices disposed in the first zone Z1 and may receive the zone data ZD generated from various kinds of sensors disposed in the first zone Z1. The virtual machine VM1 may write data in the zone data space ZDS or may read data from the zone data space ZDS. The electronic device 100 may provide an interface between the plurality of virtual machines VM1 to VM4 and the plurality of zone control units 301 to 304. The central processor 400 may be an external computing device of the electronic device 100 or may correspond to the processor 130 included in the electronic device 100.

The electronic system 10 may include at least one second storage device 200-4. The second storage device 200-4 may include only a spare space SS. The spare space SS is a space in which the zone data ZD are not stored and only the event data ED are stored. The second storage device 200-4 may not store the zone data ZD from the plurality of zone control units 301 to 304 or the plurality of virtual machines VM1 to VM4 and may store only the event data ED from the plurality of zone control units 301 to 304 or the plurality of virtual machines VM1 to VM4. The second storage device 200-4 may be a spare storage device for storing only the event data ED.

The first storage devices 200-1 to 200-3 and the second storage device 200-4 may respectively correspond to the plurality of storage devices 200 of FIG. 1. Meanwhile, the number of storage devices is not limited thereto and may be changed depending on the capacity or bandwidth necessary in the electronic system 10.

Each of the first storage devices 200-1 to 200-3 and the second storage device 200-4 may include at least one nonvolatile memory device among a memory (e.g., an SD or XD memory) of a flash memory type, a hard disk type, a multimedia card micro type, or a card type, a read-only memory (ROM), an electrically erasable programmable read-only memory (EEPROM), a programmable read-only memory (PROM), and a ferroelectric RAM (FRAM).

The electronic device 100 may write the received event data ED in the event data spaces EDS of the first storage devices 200-1 to 200-3. After the event data ED are completely written, the electronic device 100 may store a copy of the event data ED stored in the event data spaces EDS in the spare space SS included in the second storage device 200-4. The event data ED stored in the event data space EDS or the spare space SS may be set to “read-only” for the purpose of preventing data forgery.

Meanwhile, the electronic device 100 may write the received event data ED in the spare space SS. After the event data ED are completely written, the electronic device 100 may store the copy of the event data ED stored in the spare space SS of the second storage device 200-4 in the event data spaces EDS included in the first storage devices 200-1 to 200-3. The electronic device 100 may guarantee the reliability of the event data ED by distributing and storing the original and the copy of the event data ED in the first storage devices 200-1 to 200-3 and the second storage device 200-4.

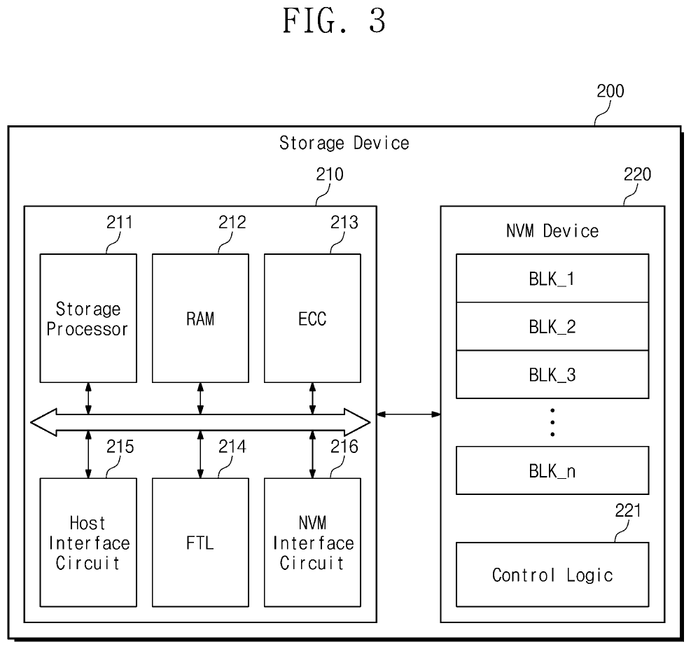

FIG. 3 is a block diagram illustrating an example of one of a plurality of storage devices of FIG. 1. Referring to FIGS. 1 and 3, the storage device 200 may include a storage controller 210 and a nonvolatile memory device 220. A storage processor 211 may control an operation of the storage controller 210 in response to a command received from a host (e.g., an electronic device) through a host interface circuit 215. For example, the storage processor 211 may control each component by using firmware for driving the storage device 200.

A RAM 212 may store instructions executable by the storage processor 211 and data processed/to be processed by the storage processor 211. For example, the RAM 212 may be implemented with a volatile memory, which has a relatively small capacity and supports a fast speed, such as a static random access memory (SRAM) or a cache memory.

An error correction code (ECC) circuit 213 may perform ECC encoding and ECC decoding by using a BCH (Bose-Chaudhuri-Hocquenghem) code, an LDPC (Low Density Parity Check) code, a turbo code, a Reed-Solomon code, a convolution code, an RSC (Recursive Systematic Code), coded modulation, such as TCM (Trellis-Coded Modulation) or BCM (Block Coded Modulation), or any other error correction code.

A flash memory translation layer manager 214 may perform an address mapping operation. The address mapping operation refers to an operation of translating a logical address received from the host into a physical address to be used to actually store data in the nonvolatile memory device 220. The flash memory translation layer manager 214 may perform a wear-leveling operation for preventing the excessive degradation of memory blocks BLK_1, BLK_2, . . . , BLK_n, a garbage collection operation for securing an available capacity in the nonvolatile memory device 220, etc. The flash memory translation layer manager 214 may perform the address mapping operation in units of specific size. For example, the flash memory translation layer manager 214 may map a logical address and a physical address in units of reference data size set to a specific size of 4 KB or 8 KB.

The host interface circuit 215 may provide the physical connection between the host and the storage device 200. That is, the host interface circuit 215 may provide an interface with the storage device 200 in compliance with the bus format of the host. In an embodiment, the bus format of the host may be the SCSI or SAS. In another embodiment, the bus format of the host may be the USB, peripheral component interconnect express (PCIe), ATA, PATA, SATA, NVMe, etc.

A nonvolatile memory interface circuit 216 may exchange data with the nonvolatile memory device 220. The nonvolatile memory interface circuit 216 may transmit data to the nonvolatile memory device 220 and may receive data read from the nonvolatile memory device 220. As will be understood by those skilled in the art, the nonvolatile memory device 220 may include the plurality of memory blocks BLK_1, BLK_2, . . . , BLK_n and control logic 221.

Each of the plurality of memory blocks BLK_1, BLK_2, . . . , BLK_n may include a plurality of pages including a plurality of memory cells, and each of the plurality of memory cells may store at least one bit depending on charges stored in a charge storage layer. The charge storage layer may be a conductive floating gate of a floating-gate structure or a trapping layer of a charge trap flash (CTF) structure. The memory cell may be programmed in various schemes such as a single level cell (SLC) scheme, a multi-level cell (MCL) scheme, a triple level cell (TLC) scheme, and a quadruple level cell (QLC) scheme.

The control logic 221 may be implemented to receive a command and an address from the storage controller 210 and to perform an operation (e.g., a program operation, a read operation, or an erase operation) corresponding to the received command with respect to memory cells corresponding to the received address.

The storage device 200 may receive the event data ED or a data fragment, which is obtained by dividing the event data ED, through the first interface circuit 110. The flash memory translation layer manager 214 may use various methods for distinguishing the event data ED from any other data. The flash memory translation layer manager 214 may use a separate namespace for the purpose of distinguishing the event data ED from any other data. A logical space where the event data ED are stored may be separately designated and may be distinguished from a logical space where any other data are stored.

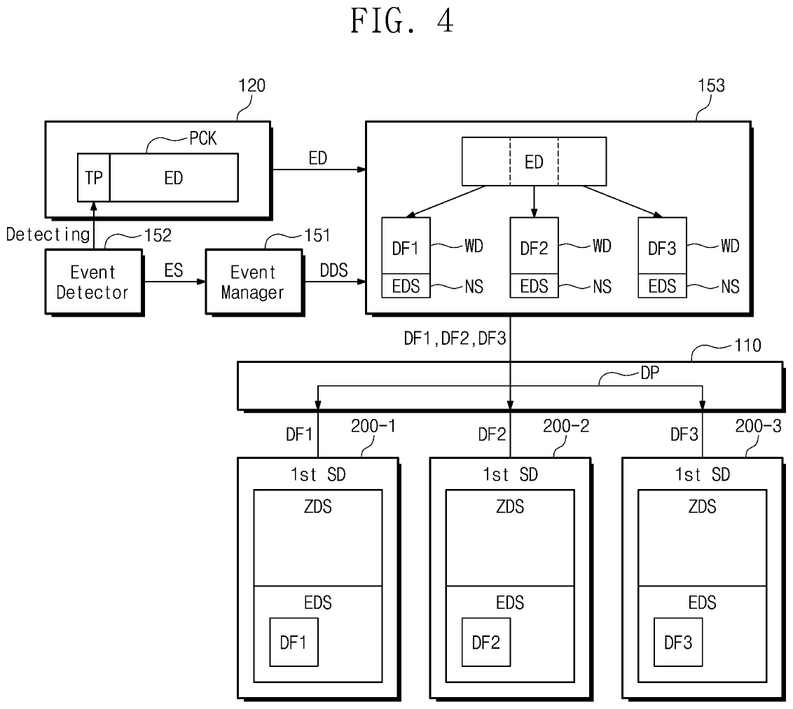

FIG. 4 is a diagram for describing an operation in which an electronic device of FIG. 1 transmits a plurality of data fragments in parallel to two or more storage devices. Referring to FIG. 4, the event detector 152 may detect the event data ED received through the second interface circuit 120. This second interface circuit 120 may receive a packet PCK from the outside of the electronic device 100. A type field (TP) included in the packet PCK may indicate that the event data ED are present in the payload (or payload field) of the packet PCK. The event detector 152 may check a value of a specific field included in the packet PCK. For example, the event detector 152 may check the type field of the packet PCK and may detect that the event data ED are included in the packet PCK. The event detector 152 may output an event signal ES as the interrupt signal in response to the detection of the event data ED.

The event manager 151 may output a data division signal DDS in response to the event signal ES from the event detector 152. In contrast, the interface manager 153 may receive the event data ED from the second interface circuit 120 and may receive the data division signal DDS from the event manager 151. The interface manager 153 may divide the event data ED into a plurality of data fragments DF1, DF2, and DF3 in response to the data division signal DDS. The interface manager 153 may divide the event data ED in units of reference data size (e.g., a data size set to 4 KB or 8 KB) applied to a storage device. The reference data size may be a unit size that is used in the mapping operation of the storage device. For example, assuming that the reference data size is set to 8 KB, the event data ED may be divided such that a data fragment has a data size corresponding to an integer multiple of 8 KB. That is, each of the plurality of data fragments DF1 to DF3 may have the size corresponding to the integer multiple of 8 KB. Meanwhile, the reference data size is provided as an example. For example, the reference data size may be set to various sizes as well as 4 KB and 8 KB. The interface manager 153 may allocate the data fragments DF1 to DF3 to two or more storage devices. For example, the interface manager 153 may allocate the first data fragment DF1 to the first storage device 200-1, may allocate the second data fragment DF2 to the first storage device 200-2, and may allocate the third data fragment DF3 to the first storage device 200-3.

The interface manager 153 may control the first interface circuit 110 such that the plurality of data fragments DF1 to DF3 are transmitted in parallel to the first storage devices 200-1 to 200-3 allocated thereto. A data path DP may be formed in the first interface circuit 110 under control of the interface manager 153. For example, the first interface circuit 110 may form the data path DP through a switching operation of at least one switch. The interface manager 153 may transmit the plurality of data fragments DF1 to DF3 corresponding to write data WD to the first interface circuit 110. The first interface circuit 110 may transmit the plurality of data fragments DF1 to DF3 corresponding to the write data WD and write commands in parallel to the plurality of first storage devices 200-1 to 200-3 corresponding thereto.

Meanwhile, the interface manager 153 may determine whether the event data ED correspond to mandatory item data or optional item data, based on the specific field of the packet PCK received through the second interface circuit 120. The interface manager 153 may divide the event data ED corresponding to the mandatory item data into the plurality of data fragments DF1 to DF3 and may not divide the event data ED corresponding to the optional item data. The interface manager 153 may divide both the mandatory item data and the optional item data.

The plurality of first storage devices 200-1 to 200-3 may respectively receive the write commands and the data fragments DF1 to DF3 corresponding to the write data WD through the first interface circuit 110. The first storage devices 200-1 to 200-3 may respectively store the data fragments DF1 to DF3 allocated thereto. And, the interface manager 153 may set a namespace NS of each of the plurality of data fragments DF1 to DF3 as the event data space EDS.

The first storage device 200-1 may store the first data fragment DF1 corresponding to the write data WD in the event data space EDS depending on the set namespace NS. The first storage device 200-2 may store the second data fragment DF2 corresponding to the write data WD in the event data space EDS depending on the set namespace NS. The first storage device 200-3 may store the third data fragment DF3 corresponding to the write data WD in the event data space EDS. The plurality of data fragments DF1 to DF3 may be stored in parallel in the event data spaces EDS. That is, while the first data fragment DF1 is stored in the event data space EDS of the first storage device 200-1, the second data fragment DF2 may be stored in the event data space EDS of the first storage device 200-2, and the third data fragment DF3 may be stored in the event data space EDS of the first storage device 200-3.

The interface manager 153 may control the first interface circuit 110 such that there is formed a data path for transmitting write data in parallel. As such, the plurality of data fragments DF1 to DF3 may be transmitted in parallel. This may mean that the time taken to write the event data ED is shortened. Meanwhile, the event data ED included in one packet PCK are described with reference to FIG. 4, but the event data ED may be data that are distributed and transmitted through a plurality of packets.

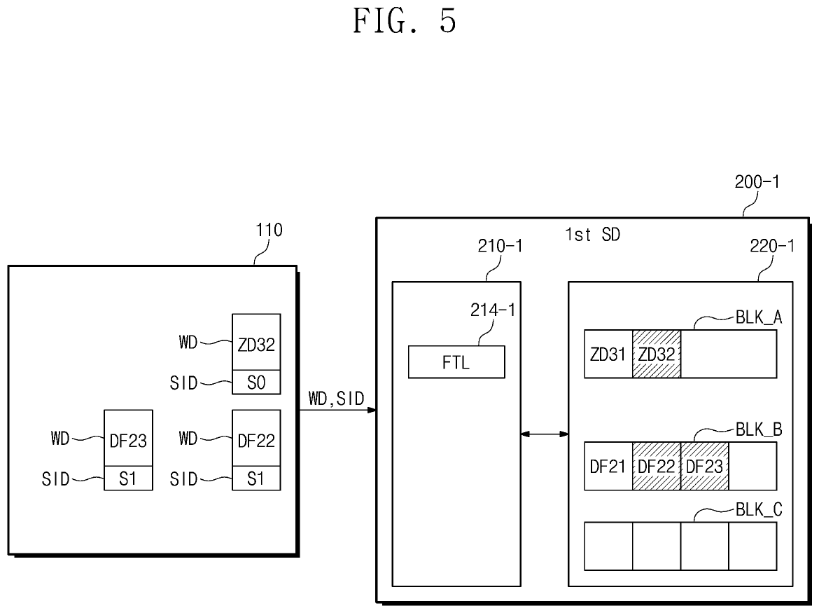

FIG. 5 is a diagram for describing a stream identifier according to an embodiment of the present disclosure. Referring to FIG. 5, the first interface circuit 110 may add a stream identifier SID to the write data WD. The first storage device 200-1 may determine a memory block in which the write data WD are to be written, based on the stream identifier SID.

The first storage device 200-1 may support a multi-stream. That is, the first storage device 200-1 may classify and process data depending on the stream identifier SID. For example, the first storage device 200-1 may allocate the same memory block for data having the same stream identifier SID. A data fragment DF22 and a data fragment DF23 may be data fragments divided from different event data ED. The first interface circuit 110 may add the stream identifier SID of S0 to zone data ZD32 and may add the stream identifier SID of S1 to the data fragment DF22 and the data fragment DF23 that are obtained by dividing the event data ED.

The first storage device 200-1 may receive the write data WD and the stream identifier SID. A flash memory translation layer manager 214-1 included in a storage controller 210-1 may map a logical address of the write data WD to a physical address based on the stream identifier SID. In this case, the mapping may be made such that write data corresponding to the same stream identifier SID are written in the same memory block among a plurality of memory blocks included in a nonvolatile memory device 220-1. For example, the flash memory translation layer manager 214 may identify that the stream identifier SID of the zone data ZD32 is S0. The zone data ZD32 may be written in a memory block BLK_A of the nonvolatile memory device 220-1, in which zone data ZD31 are previously stored.

The flash memory translation layer manager 214 may identify that the stream identifier SID of the data fragment DF22 is S1 and may write the data fragment DF22 in a memory block BLK_B where a data fragment DF21 is previously stored. The flash memory translation layer manager 214 may identify that the stream identifier SID of the data fragment DF23 is S1 and may write the data fragment DF23 in the memory block BLK_B where the data fragment DF21 and the data fragment DF22 are previously stored.

In a state where the memory block BLK_B is fully filled with data, when the write data WD whose stream identifier SID is S1 are received, the flash memory translation layer manager 214 may map a memory block BLK_C different from the memory block BLK_B to a logical address of the write data WD. Afterwards, the flash memory translation layer manager 214 may write the write data WD, whose stream identifier SID is identified to be S1, in the memory block BLK_C.

As the first interface circuit 110 adds the same stream identifier SID to the data fragments DF22 and DF23 of the event data ED, the physical space of the data fragments DF22 and DF23 may be separated from the physical space of any other data. That is, the electronic device 100 may distinguish event data from any other data so as to be stored in different physical spaces. As such, the storage device may efficiently manage the stored data.

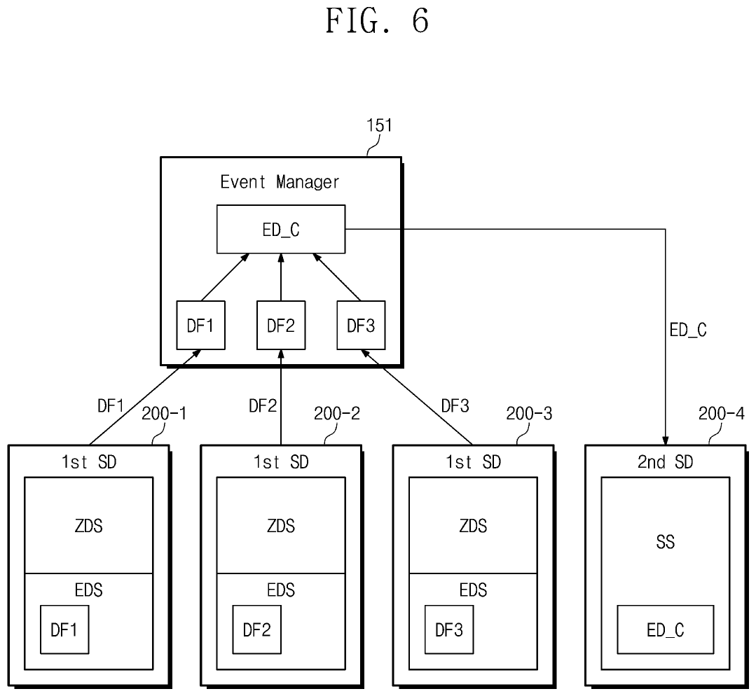

FIG. 6 is a diagram for describing an operation of storing combined event data according to an embodiment of the present disclosure. Referring to FIGS. 4 and 6, the event manager 151 may read the plurality of data fragments DF1, DF2, and DF3 respectively stored in the event data spaces EDS of the plurality of first storage devices 200-1, 200-2, and 200-3. The event manager 151 may combine the plurality of data fragments DF1 to DF3 to generate event data ED_C. The event data ED_C are the same data as the event data ED received through the second interface circuit 120 before the division into the data fragments DF1 to DF3 described with reference to FIG. 4.

The event data ED_C combined by the event manager 151 may be stored in the spare space SS of the second storage device 200-4. The event data ED_C stored in the spare space SS may be set to “read-only data”. That is, the event data ED_C stored in the spare space SS may be prevented from being forged (e.g., deleted or modified). As such, the reliability of the event data ED_C may be secured.

The event manager 151 may combine the data fragments DF1, DF2, and DF3. The event manager 151 may generate combined event data ED_C through data combination. The event manager 151 may transmit the combined event data ED_C to a spare storage device among a plurality of storage devices.

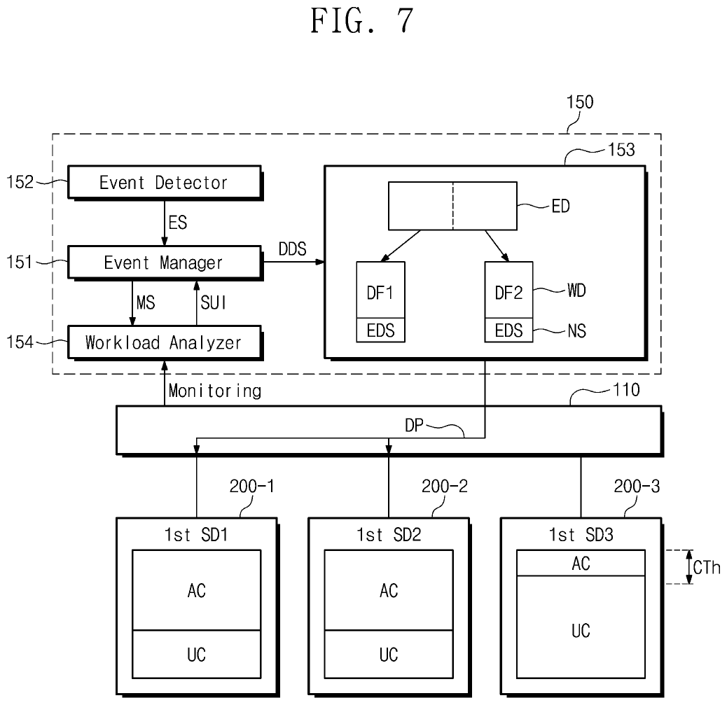

FIG. 7 is a diagram for describing how a data division operation is performed based on an available capacity of each of a plurality of storage devices, according to an embodiment of the present disclosure. Referring to FIG. 7, the event processing circuit 150 of electronic device 100 may further include a workload analyzer 154.

The event manager 151 may output a monitoring signal MS in response to the event signal ES from the event detector 152. The workload analyzer 154 may monitor a state of each of the plurality of the first storage devices 200-1 to 200-3 in response to the monitoring signal MS. As such, the workload analyzer 154 may identify the state of a storage device including an available capacity, for each of the plurality of the first storage devices 200-1 to 200-3. For example, the workload analyzer 154 may identify a used capacity UC and an available capacity AC for each of the plurality of first storage devices 200-1 to 200-3. In an embodiment, the used capacity UC may refer to a capacity where data are previously stored, and the available capacity AC may refer to a capacity where data are capable of being stored.

The workload analyzer 154 may generate storage usage information SUI being status information of the plurality of first storage devices 200-1 to 200-3. The workload analyzer 154 may transmit the storage usage information SUI to the event manager 151. Then, the event manager 151 may transmit the data division signal DDS to the interface manager 153 based on the storage usage information SUI.

The interface manager 153 may divide the event data ED into the plurality of data fragments DF1 and DF2 based on the available capacity AC of each of the first storage devices 200-1 to 200-3. For example, the interface manager 153 may determine the number of data fragments depending on the number of storage devices in which the available capacity AC is greater than a threshold capacity CTh. The available capacity AC of the first storage device 200-1 and the available capacity AC of the first storage device 200-2 are greater than the threshold capacity CTh, and the available capacity AC of the first storage device 200-3 is smaller than the threshold capacity CTh. Accordingly, when dividing the event data ED, the interface manager 153 may determine that the number of data fragments is two (2). The interface manager 153 may divide the event data ED into two data fragments DF1 and DF2 depending on the number of data fragments thus determined. The example in which the interface manager 153 divides the event data ED into two data fragments DF1 and DF2 is described above, but the number of data fragments may be determined to be appropriate for data transmission without the limitation to two (2).

The interface manager 153 may allocate the first data fragment DF1 to the first storage device 200-1 and may allocate the second data fragment DF2 to the first storage device 200-2. The interface manager 153 may set the namespace NS of each of the plurality of data fragments DF1 and DF2 as the event data space EDS.

The interface manager 153 may transmit the data fragments DF1 and DF2 corresponding to the write data WD to the first storage device 200-1 and the first storage device 200-2 through the first interface circuit 110, respectively. The interface manager 153 may control the first interface circuit 110 such that there is formed a data path for transmitting write data in parallel. The first interface circuit 110 may transmit the data fragments DF1 and DF2 to the first storage device 200-1 and the first storage device 200-2 in parallel along the formed data path DP. As such, a time taken to store the event data ED may be shortened.

The first storage device 200-1 may store the first data fragment DF1 corresponding to the write data WD in the event data space EDS depending on the set namespace NS. The first storage device 200-2 may store the second data fragment DF2 corresponding to the write data WD in the event data space EDS depending on the set namespace NS.

The plurality of data fragments DF1 and DF2 may be stored in parallel in the event data spaces EDS. That is, while the first data fragment DF1 is stored in the event data space EDS of the first storage device 200-1, the second data fragment DF2 may be stored in the event data space EDS of the first storage device 200-2.

Data input/output speeds of the first storage devices 200-1 to 200-3 may be different depending on the available capacity AC. The threshold capacity CTh may be set to a capacity of a boundary where the reduction of speed of a storage device occurs. That is, a data fragment may not be allocated to the first storage device 200-3 where the reduction of speed occurs, and the data fragments DF1 and DF2 may be respectively transmitted to the first storage devices 200-1 and 200-2 where the reduction of speed does not occur. As such, the event data ED may be quickly stored.

Also, as the interface manager 153 may appropriately distribute an available space of the first storage devices 200-1 to 200-3 by storing the data fragments DF1 and DF2 of the event data ED in the first storage devices 200-1 and 200-2 where the available capacity AC is secured.

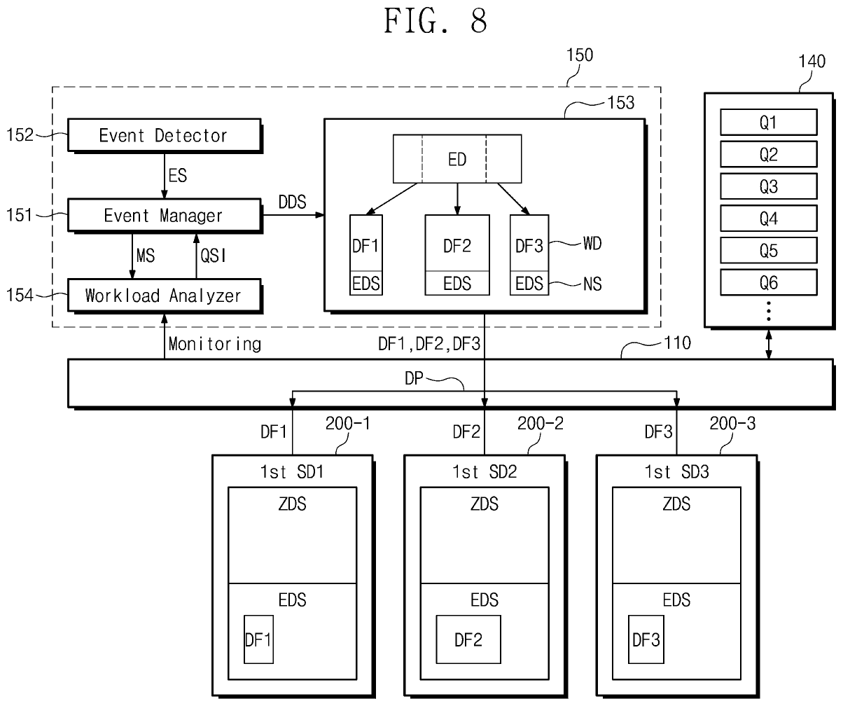

FIG. 8 is a diagram for describing how a data division operation is performed based on states of a plurality of queues, according to an embodiment of the present disclosure. Referring to FIG. 8, the event manager 151 may output the monitoring signal MS in response to the event signal ES.

The workload analyzer 154 may monitor states of a plurality of queues Q1, Q2, etc. in response to the monitoring signal MS. As such, the workload analyzer 154 may identify states of the plurality of queues Q1, Q2, etc. The plurality of queues Q1, Q2, etc. may be submission queues storing commands to be submitted to the first storage devices 200-1, 200-2, and 200-3 or may be completion queues storing information that the commands submitted to the first storage devices 200-1, 200-2, and 200-3 are completed.

Because commands not processed by the first storage devices 200-1 to 200-3 are present in some or all of the plurality of queues Q1, Q2, etc., the workload analyzer 154 may check states of the plurality of queues Q1, Q2, etc. to identify workloads of the first storage devices 200-1 to 200-3. The workload analyzer 154 may transmit queue status information QSI about the states of the plurality of queues Q1, Q2, etc. to the event manager 151. The event manager 151 may transmit the data division signal DDS, which is based on the queue status information QSI, to the interface manager 153.

The interface manager 153 may divide the event data ED into the plurality of data fragments DF1, DF2, and DF3 based on the workloads of the first storage devices 200-1 to 200-3 according to the states of the plurality of queues Q1, Q2, etc. For example, the interface manager 153 may determine sizes of the plurality of data fragments DF1 to DF3 depending on the workloads of the plurality of first storage devices 200-1 to 200-3. As an example, the interface manager 153 may determine the size of the data fragment to be inversely proportional to the workload of each of the plurality of first storage devices 200-1 to 200-3. Assuming that the workload of the first storage device 200-1 is the greatest and the workload of the first storage device 200-2, when dividing the event data ED into the plurality of data fragments DF1 to DF3, the interface manager 153 may determine the size of the data fragment DF1 to be smaller than the sizes of the remaining data fragments DF2 and DF3 and may determine the size of the data fragment DF2 to be greater than the remaining data fragments DF1 and DF3.

For example, the interface manager 153 may allocate the first data fragment DF1 to the first storage device 200-1, may allocate the second data fragment DF2 to the first storage device 200-2, and may allocate the third data fragment DF3 to the first storage device 200-3. The interface manager 153 may set the namespace NS of each of the plurality of data fragments DF1 to DF3 as the event data space EDS.

The interface manager 153 may transmit the data fragments DF1 to DF3 corresponding to the write data WD to the first storage device 200-1, the first storage device 200-2, and the first storage device 200-3 in parallel. The first storage device 200-1 may store the first data fragment DF1 corresponding to the write data WD in the event data space EDS depending on the set namespace NS. The first storage device 200-2 may store the second data fragment DF2 corresponding to the write data WD in the event data space EDS depending on the set namespace NS. The first storage device 200-3 may store the third data fragment DF3 corresponding to the write data WD in the event data space EDS depending on the set namespace NS.

The plurality of data fragments DF1 to DF3 may be stored in parallel in the event data spaces EDS. That is, while the first data fragment DF1 is stored in the event data space EDS of the first storage device 200-1, the second data fragment DF2 may be stored in the event data space EDS of the first storage device 200-2, and the third data fragment DF3 may be stored in the event data space EDS of the first storage device 200-3.

The interface manager 153 may control the first interface circuit 110 such that there is formed a data path for transmitting write data in parallel. As such, the plurality of data fragments DF1 to DF3 may be transmitted in parallel. This may mean that the time taken to write the event data ED is shortened.

The workloads of the first storage devices 200-1 to 200-3 may be different. The first data fragment DF1 of a small size may be allocated to the first storage device 200-1 having a great workload, and the third data fragment DF3 of a great size may be allocated to the first storage device 200-3 having a small workload. As such, the workloads of the first storage devices 200-1 to 200-3 may be balanced.

Meanwhile, the size of each of the data fragments DF1 to DF3 may be determined based on the reference data size. As an example, it is assumed that the reference data size is 8 KB. In this case, the size of the first data fragment DF1 may be 8 KB, the size of the second data fragment DF2 may be 24 KB, and the size of the third data fragment DF3 may be 16 KB. That is, the event data ED may be divided into the data fragments DF1 to DF3, each of which has a size corresponding to an integer multiple of 8 KB.

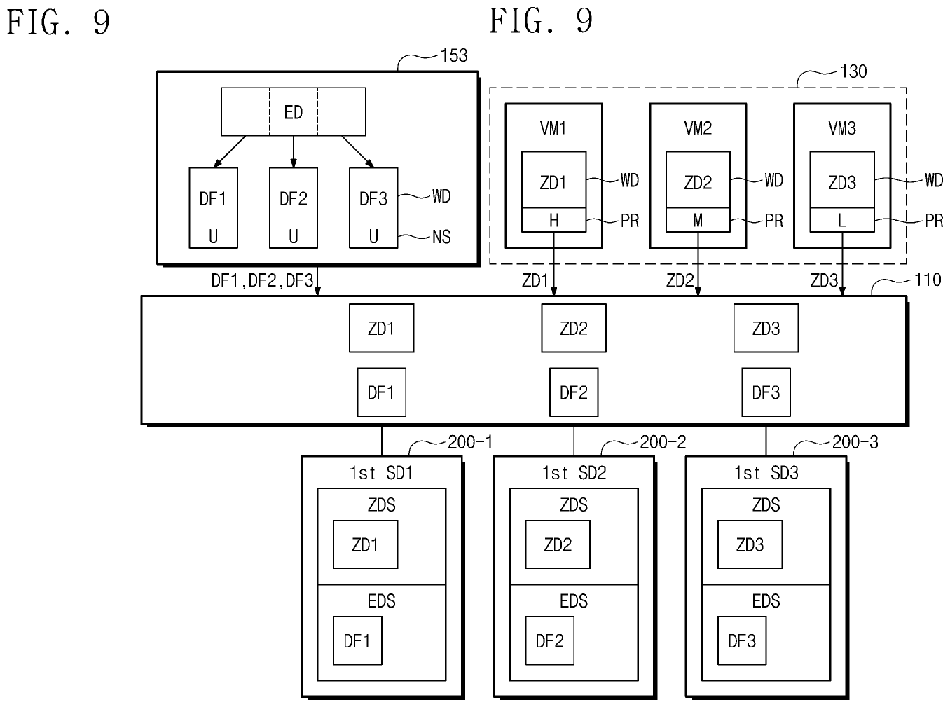

FIG. 9 is a diagram for describing an operation of transmitting data to each of a plurality of storage devices based on a priority of data, according to an embodiment of the present disclosure. Referring to FIG. 9, the interface manager 153 may divide the event data ED into the plurality of data fragments DF1, DF2, and DF3. The interface manager 153 may set a priority PR of the plurality of data fragments DF1 to DF3 to the highest value. The interface manager 153 may allocate the first data fragment DF1 to the first storage device 200-1, may allocate the second data fragment DF2 to the first storage device 200-2, and may allocate the third data fragment DF3 to the first storage device 200-3.

For example, the priority PR applied to the first interface circuit 110 may be one of an urgent level “U”, a high level “H”, a middle level “M”, and a low level “L”. In the priority PR that is set to one of the urgent level “U”, the high level “H”, the middle level “M”, and the low level “L”, the urgent level “U” may be the highest, and the low level “L” may be the lowest. The interface manager 153 may set the priority PR of the plurality of data fragments DF1, DF2, and DF3 to the urgent level “U”.

The processor 130 may execute the plurality of virtual machines VM1 to VM3. Each of the plurality of virtual machines VM1 to VM3 may control the corresponding zone. The virtual machine VM1 may generate the zone data ZD1. The virtual machine VM1 may transmit the zone data ZD1 to the first interface circuit 110 so as to be written in the first storage device 200-1. In this case, the virtual machine VM1 may set the priority PR to the high level “H” depending on importance of the zone data ZD1. The virtual machine VM2 may generate the zone data ZD2. The virtual machine VM2 may transmit the zone data ZD2 to the first interface circuit 110 so as to be written in the first storage device 200-2. In this case, the virtual machine VM2 may set the priority PR to the middle level “M” depending on importance of the zone data ZD2. The virtual machine VM3 may generate the zone data ZD3. The virtual machine VM3 may transmit the zone data ZD3 to the first interface circuit 110 so as to be written in the first storage device 200-3. In this case, the virtual machine VM3 may set the priority PR to the low level “L” depending on importance of the zone data ZD3.

The first interface circuit 110 may change the order of transmitting the data fragments DF1 to DF3 and the zone data ZD1 to ZD3 to the plurality of first storage devices 200-1 to 200-3 depending on the priorities of the data fragments DF1 to DF3 and the zone data ZD1 to ZD3. For example, the first interface circuit 110 may receive the write data WD with the priority PR from the processor 130. The write data WD of the first storage device 200-1 are the zone data ZD1, the write data WD of the first storage device 200-2 are the zone data ZD2, and the write data WD of the first storage device 200-3 are the zone data ZD3.

Before the first interface circuit 110 transmits the zone data ZD1 to ZD3 to the plurality of first storage devices 200-1 to 200-3, the first interface circuit 110 may receive the plurality of data fragments DF1 to DF3 from the interface manager 153. In this case, the priority PR of the plurality of data fragments DF1 to DF3 corresponds to the urgent level “U”, the priority of the zone data ZD1 corresponds to the high level “H”, the priority of the zone data ZD2 corresponds to the middle level “M”, and the priority of the zone data ZD3 corresponds to the low level “L”,

Before the first interface circuit 110 transmits the zone data ZD1 to ZD3 to the corresponding storage devices 200-1 to 200-3, respectively, the first interface circuit 110 may transmit the data fragments DF1 to DF3 to the corresponding storage devices 200-1 to 200-3, respectively. After the data fragments DF1 to DF3 are completely transmitted, the first interface circuit 110 may transmit the zone data ZD1 to ZD3 to the corresponding storage devices 200-1 to 200-3, respectively.

As such, the data fragments DF1 to DF3 of the event data ED may be written in the first storage devices 200-1 to 200-3 prior to any other data. Because the event data ED are data requiring a fast record, the data fragments DF1 to DF3 may be stored in the first storage devices 200-1 to 200-3 prior to any other data, and thus, the reliability of the event data ED may increase.

Meanwhile, in the event data ED, the priority PR of only mandatory item data may be set to the highest value, and the priority PR of optional item data may be set to a default value. The default value may be a value corresponding to the priority PR set in a packet in which the event data ED is included.

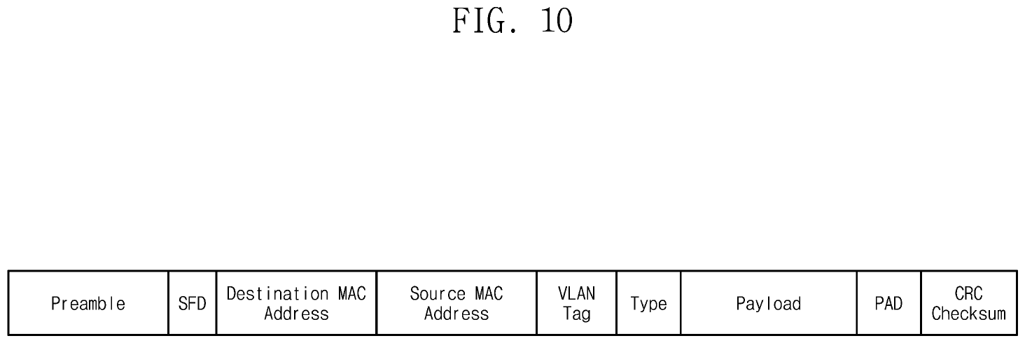

FIG. 10 is a diagram illustrating an Ethernet frame according to an embodiment of the present disclosure. Referring to FIG. 10, an Ethernet frame may include a VLAN tag field and a type field. A preamble field may be a field informing an input of an Ethernet packet and may be used for timing synchronization.

A start frame indicator (SFD) field is a field indicating a start of the Ethernet frame and indicates that a destination MAC address field starts following the start frame indicator (SFD).

The destination MAC address field is a field indicating a physical address of a receive side receiving a packet. The second interface circuit 120 may include an Ethernet interface. When the electronic device 100 of FIG. 1 receives the event data ED, the destination MAC address of the Ethernet packet that the second interface circuit 120 receives may correspond to a physical address of the Ethernet interface included in the second interface circuit 120.

A source MAC address field is a field indicating a physical address of a device transmitting the Ethernet packet. When the electronic device 100 of FIG. 2 receives the event data ED, the source MAC address of the Ethernet packet that the electronic device 100 receives may be a physical address of a zone control unit generating the Ethernet packet from among the plurality of zone control units 301, 302, 303, and 304.

The VLAN tag field is a field indicating an identifier used in virtual local area networking. The VLAN tag field may include a priority code point (PCP) field indicating a priority. The type field may define a length of a data field or may indicate an Ethertype.

A payload field is a field of a variable length and includes data to be transmitted through the Ethernet packet. A PAD field that is a padding that is added to meet a minimum length of the payload may be added when the length of the payload is shorter than the minimum length. A CRC checksum field is a field that is filled to detect an error of the Ethernet packet. The CRC checksum is used to detect a bit error occurring in the Ethernet frame through cyclic redundancy check.

The electronic device 100 of FIG. 1 may receive the Ethernet packet including the event data ED through the second interface circuit 120. The event detector 152 may detect the Ethernet packet and may determine whether event data are present in the payload field or may determine a type of the event data. For example, the event detector 152 may determine whether the event data ED are present in the payload field, based on the VLAN tag field or type field included in the Ethernet packet. The event detector 152 may determine whether the event data ED are present in the payload field, based on a sub-field included in the payload field. The event detector 152 may determine whether the event data ED are mandatory item data or optional item data, based on the VLAN tag field, the type field, or the sub-field of the payload field, which is included in the Ethernet packet.

The interface manager 153 may determine whether the event data ED of the payload field are mandatory item data or optional item data, based on the VLAN tag field or the type field included in the Ethernet packet. The interface manager 153 may determine whether the event data ED of the payload field are mandatory item data or optional item data, based on the sub-field included in the payload field.

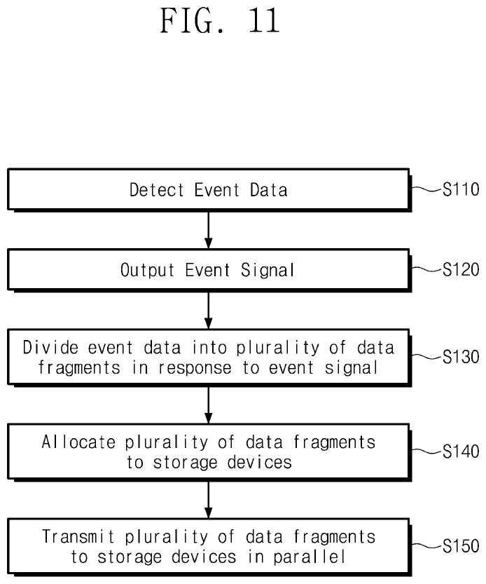

FIG. 11 is a flowchart illustrating an operation method of an electronic device according to an embodiment of the present disclosure. Referring to FIG. 11, according to an embodiment of the present disclosure, an operation method of the electronic device 100 mounted on an autonomous vehicle may include detecting event data (S110). The operation method of the electronic device 100 mounted on the autonomous vehicle may include outputting an event signal when the event data are detected (S120).

The operation method of the electronic device 100 mounted on the autonomous vehicle may include dividing the event data into a plurality of data fragments in response to the event signal (S130). The operation method of the electronic device 100 mounted on the autonomous vehicle may include allocating the plurality of data fragments to two or more storage devices (S140). The operation method of the electronic device 100 mounted on the autonomous vehicle may include transmitting the plurality of data fragments to the allocated storage devices in parallel (S150).

Meanwhile, the operation method of the electronic device 100 mounted on the autonomous vehicle may include identifying an available capacity of each of a plurality of storage devices in response to the event signal. In this case, operation S130 may include determining the number of data fragments based on the available capacity of each of the plurality of storage devices.

In an embodiment, the operation method of the electronic device 100 mounted on the autonomous vehicle may further include identifying states of a plurality of queues respectively corresponding to the plurality of storage devices in response to the event signal. In this case, operation S130 may further include determining a size of each of the plurality of data fragments based on the states of the plurality of queues.

Meanwhile, the operation method of the electronic device 100 mounted on the autonomous vehicle may further include identifying a type of the event data, setting a priority of the plurality of data fragments to the highest value based on that the event data are of a first type, and changing the order of transmitting data to the two or more storage devices based on the priority.

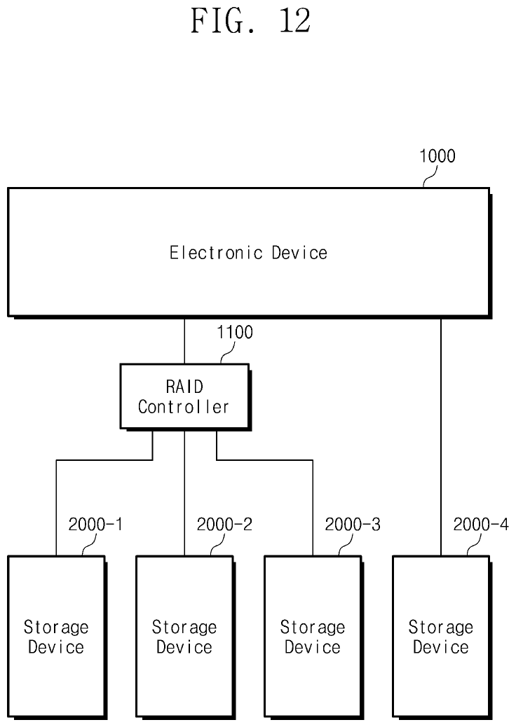

FIG. 12 is a diagram illustrating a configuration of a plurality of storage devices according to another embodiment of the present disclosure. Referring to FIG. 12, an electronic system according to another embodiment of the present disclosure may include an electronic device 1000, a RAID (Redundant Array of Independent Disks) controller 1100, and a plurality of storage devices 2000-1, 2000-2, 2000-3, and 2000-4.

The storage device 2000-1, the storage device 2000-2, and the storage device 2000-3 may constitute a RAID storage system. That is, the storage devices 2000-1 to 2000-3 may constitute one high-capacity storage device. As such, the electronic device 1000 may distribute and store zone data and event data to the storage devices 2000-1 to 2000-3. In this case, even though a failure occurs in one storage device, the electronic device 1000 may recover data. One of the storage devices 2000-1 to 2000-3 constituting the RAID storage system may store RAID parity information. Each of some or all of the storage devices 2000-1 to 2000-3 may include an area storing the RAID parity information.

The RAID controller 3100 may control the storage devices 2000-1 to 2000-3 such that the storage devices 2000-1 to 2000-3 constitute the RAID storage system. The RAID controller 3100 may be implemented separately outside the electronic device 1000 as illustrated or may be implemented within the electronic device 1000. Each of the storage devices 2000-1 to 2000-3 may include the zone data space ZDS and the event data space EDS logically distinguished from each other, like the first storage devices 200-1, 200-2, and 200-3 of FIG. 2. A storage device 2000-4 may include the spare space SS like the second storage device 200-4 of FIG. 2. The storage device 2000-4 may store only a copy of the event data ED.

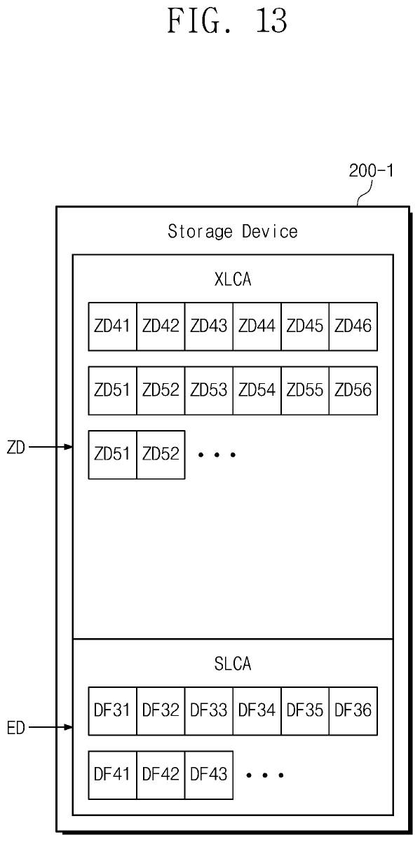

FIG. 13 is a diagram for describing an example of a storage area of a storage device of FIG. 2. Referring to FIG. 13, the storage device 200-1 may include an XLC area XLCA and an SLC area SLCA. The XLC area XLCA is an area where one memory cell stores at least two or more bits. Data may be written in the XLC area XLCA in the following scheme: 1) a multi-level cell (MLC) scheme in which one memory cell stores two bits, 2) a triple level cell (TLC) scheme in which one memory cell stores three bits, or 3) a quad-level cell (QLC) scheme in which one memory cell stores four bits. The XLC area XLCA provides a relatively great capacity by using a small number of memory cells, and thus, the XLC area XLCA is appropriate for storing a large amount of data. The storage device 200-1 may store the zone data ZD received from the electronic device 100 of FIG. 2 in the XLC area XLCA.

The SLC area SLCA is an area where one memory cell stores one bit. The SLC area SLCA may store data quickly compared to the XLC area XLCA. Also, because a distance between threshold voltage distributions of memory cells in the SLC area SLCA is relatively great, the SLC area SLCA may be advantageous in retaining the data stored therein. The storage device 200-1 may store the data fragments DF obtained by dividing the event data ED received from the electronic device 100. As the data fragments DF are written in the SLC area SLCA, the storage device 200-1 may quickly store the event data ED in a situation where a trigger condition is satisfied, and thus, the reliability of the event data ED may be guaranteed.

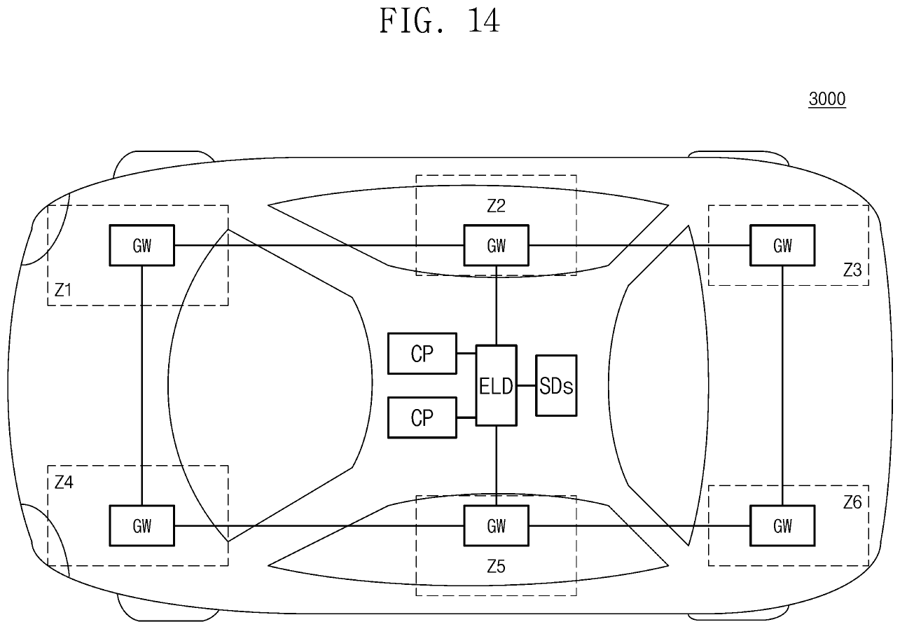

FIG. 14 is a diagram illustrating an automotive zonal & centralized architecture of an autonomous vehicle. Referring to FIG. 14, an autonomous vehicle 3000 may include a plurality of zones Z1, Z1, . . . , Z6. The automotive zonal & centralized architecture being one of electric/electronic system architectures may be applied to the autonomous vehicle 3000.

The first zone Z1 is a zone corresponding to the right front part of the autonomous vehicle 3000, the second zone Z2 is a zone corresponding to the right side part of the autonomous vehicle 3000, and the third zone Z3 is a zone corresponding to the right rear part of the autonomous vehicle 3000. The fourth zone Z4 is a zone corresponding to the left front part of the autonomous vehicle 3000, the fifth zone Z5 is a zone corresponding to the left side part of the autonomous vehicle 3000, and the sixth zone Z6 is a zone corresponding to the left rear part of the autonomous vehicle 3000. Electronic control devices, such as various kinds of sensors, a camera, an LIDAR, an actuator, and an inertial measurement unit, a gate way may be included in each of the plurality of zones Z1, Z1, . . . , Z6. A gate way GW may transmit data generated in the corresponding zone to a gate way GW adjacent thereto or an electronic device ELD. The electronic device ELD may receive the zone data generated in the plurality of zones Z1, Z1, . . . , Z6. For example, the zone data generated in the first zone Z1 may be transmitted to the gate way GW of the first zone Z1 and may then be transmitted to the electronic device ELD through the gate way GW of the second zone Z2.

Event data may be generated in the plurality of zones Z1, Z1, . . . , Z6 and may be transmitted to the electronic device ELD in the same scheme as the zone data. Meanwhile, the plurality of zones Z1, Z1, . . . , Z6 of the autonomous vehicle 3000 may be set in various schemes.

The autonomous vehicle 3000 may include one or more central processors CP. The central processors CP may execute virtual machines for controlling the plurality of zones Z1, Z1, . . . , Z6. The central processors CP may be implemented to be independent of the electronic device ELD as illustrated in FIG. 14. However, the present disclosure is not limited thereto. For example, the central processors CP may be implemented within the electronic device ELD. In this case, the central processors CP may correspond to processors of the electronic device ELD.

The autonomous vehicle 3000 may include a plurality of storage devices SDs. The zone data or the event data generated in the plurality of zones Z1, Z1, . . . , Z6 may be stored in the plurality of storage devices SDs through the electronic device ELD. Zone data generated in the central processor CP may also be stored in the plurality of storage devices SDs through the electronic device ELD.

According to an embodiment of the present disclosure, an electronic device mounted on an autonomous vehicle, an electronic system including the same, and an operation method thereof may make it possible to divide event data associated with an accident of a vehicle into a plurality of data fragments and to write the plurality of data fragments in a plurality of storage devices in parallel. As such, the event data may be quickly recorded, and the loss of the event data may be prevented.

The size of data generated in the architecture of the autonomous vehicle is increasing. In the case of failing to quickly store the data generated in the vehicle in the event of an accident, data necessary to analyze the cause of the accident may be lost due to a breakdown of the vehicle. Accordingly, there is required a method capable of quickly storing data generated in the event of an accident.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An electronic device configured to be mounted on an autonomous vehicle, comprising:
a first interface circuit configured to communicate with a plurality of storage devices;
a second interface circuit configured to communicate with a plurality of zones of the autonomous vehicle;
an event detector configured to output an event signal in response to detecting event data received through the second interface circuit;
an event manager configured to output a data division signal in response to the event signal; and
an interface manager configured to: divide the event data into a plurality of data fragments in response to the data division signal, allocate the plurality of data fragments to two or more storage devices among the plurality of storage devices, respectively, and control the first interface circuit such that the plurality of data fragments are respectively transmitted to the allocated two or more storage devices.

2. The electronic device of claim 1, wherein the plurality of data fragments are divided in units of reference data size and are written in event data spaces respectively included in the two or more storage devices.

3. The electronic device of claim 2, wherein the first interface circuit adds the same stream identifier to each of the plurality of data fragments.

4. The electronic device of claim 2, wherein the event manager is further configured to:
generate combined event data through a combination of the data fragments stored in the event data spaces; and
transmit the combined event data to a spare storage device among the plurality of storage devices.

5. The electronic device of claim 1,
wherein the event manager is configured to output a monitoring signal based on the event signal;
wherein the electronic device further comprises a workload analyzer configured to identify an available capacity of each of the plurality of storage devices in response to the monitoring signal; and
wherein the interface manager divides the event data into the plurality of data fragments based on the available capacity of each of the plurality of storage devices.

6. The electronic device of claim 5,
wherein the workload analyzer is further configured to identify states of a plurality of queues respectively corresponding to the plurality of storage devices in response to the monitoring signal; and
wherein the interface manager is configured to divide the event data into the plurality of data fragments based on the available capacity of each of the plurality of storage devices.

7. The electronic device of claim 1, wherein the interface manager is configured to: identify a type of the event data, and set a priority of the plurality of data fragments to a highest value in response to the event data being identified to be of a first type.

8. The electronic device of claim 7, wherein the first interface circuit is configured to change an order of data to be transmitted to each of the plurality of storage devices based on the priority.

9. The electronic device of claim 1, wherein the second interface circuit includes an Ethernet interface.

10. The electronic device of claim 9, wherein the event detector is configured to identify the event data based on at least one of fields included in a packet received through the second interface circuit.

11. An electronic system, comprising:
an electronic device configured to be mounted on an autonomous vehicle;
zone control units respectively corresponding to a plurality of zones of the autonomous vehicle; and
a plurality of first storage devices each including an event data space
wherein the electronic device is configured to:
divide event data received from one of the zone control units into a plurality of data fragments;
allocate the plurality of data fragments to two or more first storage devices among the plurality of first storage devices; and
transmit the plurality of data fragments to corresponding ones of the two or more first storage devices; and
wherein each of the two or more first storage devices are configured to write the corresponding data fragment among the plurality of data fragments in the event data space.

12. The electronic system of claim 11, wherein the electronic device is configured to add the same stream identifier to each of the plurality of data fragments; and wherein each of the two or more first storage devices is configured to write the corresponding data fragment in the same memory block based on the stream identifier.

13. The electronic system of claim 11, further comprising:
at least one second storage device; and
wherein the electronic device is configured to:
generate combined event data through a combination of the plurality of data fragments written in the respective event data spaces of the two or more first storage devices; and
write the combined event data in the second storage device.

14. The electronic system of claim 11, wherein the electronic device is configured to:
identify an available capacity of each of the plurality of first storage devices; and
divide the event data into the plurality of data fragments based on the available capacity of each of the plurality of first storage devices.

15. The electronic system of claim 14, wherein the electronic device is configured to:
identify states of a plurality of queues respectively corresponding to the plurality of first storage devices; and
divide the event data into the plurality of data fragments based on the states of the plurality of queues.

16. The electronic system of claim 11, wherein the electronic device is configured to: identify a type of the event data, set a priority of the plurality of data fragments to a highest value in response to the event data being identified to be of a first type, and change an order of transmitting the plurality of data fragments to the two or more first storage devices based on the priority.

17. A method of operating an electronic device configured to be mounted on an autonomous vehicle, comprising:
detecting event data;
outputting an event signal in response to detection of the event data;
dividing the event data into a plurality of data fragments in response to the event signal;
allocating the plurality of data fragments to two or more storage devices; and
transmitting the plurality of data fragments to the allocated two or more storage devices.

18. The method of claim 17, further comprising:
identifying an available space of each of the plurality of storage devices in response to the event signal;
wherein the dividing includes determining a number of the plurality of data fragments based on the available space of each of the plurality of storage devices; and
wherein the transmitting includes transmitting the plurality of data fragments in parallel to the two or more storage devices.

19. The method of claim 18, further comprising:
identifying states of a plurality of queues respectively corresponding to the plurality of storage devices in response to the event signal; and
wherein the dividing includes determining a size of each of the plurality of data fragments based on the states of the plurality of queues.

20. The method of claim 17, further comprising:
identifying a type of the event data;
setting a priority of the plurality of data fragments to a highest value based on that the event data that are identified to be of a first type; and
changing an order of transmitting the plurality of data fragments to the two or more storage devices based on the priority.
